(19) United States
(12) Patent Application Publication
(10) Pub. No.: US 2011/0093813 A1
(43) Pub. Date: Apr. 21, 2011

(54) IMAGE FORMING APPARATUS AND PROGRAM CONTROLLING METHOD

(75) Inventor: Hidehiko WATANABE, Kanagawa (JP)

(73) Assignee: RICOH COMPANY, LTD., Tokyo (JP)

(21) Appl. No.: 12/903,275

(22) Filed: Oct. 13, 2010

(30) Foreign Application Priority Data
Oct. 16, 2009 (JP) 2009-238979

(51) Int. Cl. G06F 3/048

(52) U.S. Cl. 715/810

(57) ABSTRACT

A disclosed image forming apparatus includes a management unit configured to receive an instruction for operating a second program which can be dynamically inserted into a first program installed in the image forming apparatus, a control unit configured to carry out a process corresponding to the instruction for operating the second program in response to the instruction received via the management unit, an install unit configured to install a program which causes the image forming apparatus function as the management unit, wherein the management unit causes a first screen for enabling selecting the second program to be displayed on a display unit, acquires the second program selected from the first screen, and instructs the control unit to validate the acquired second program, and the control unit applies the second program by inserting the second program into the first program in response to the instruction to validate the second program.

### BACKGROUND OF THE INVENTION

1. Field of the Invention

The present invention generally relates to an image forming apparatus and a program controlling method, and more specifically, to an image forming apparatus which realizes a function by controlling a program and a program controlling method for controlling the program.

2. Description of the Related Art

An example of a typical operation of an apparatus into which a program is installed is an analysis of logs obtained from the program operated by the apparatus. For example, commands used for outputting the value of a variable used by a program and information indicative of a state of hardware, by which the program is operated, to a log file are previously embedded in various portions of the source code of the program. When a failure occurs, by analyzing the log file output in accordance with the command (hereinafter referred to as “log output command”), it is possible to presume or specify a cause of the failure.

However, a substantial number of the log files (first output log files) output based on previously embedded log output commands may be insufficient for detailed analyses. In this case, the first output log files may be used to narrow down the portion of the failure to some extent. Subsequently, a program source code may be modified to output a further detailed log at and around the portion of the failure. Then, the program is replaced by the modified program after the modified program is compiled and linked. If the cause, i.e. the portion of the failure, cannot be specified by a new log file output using the modified program, a log output command is further embedded in the source code, and the cause may be tried to be specified by repeating the above procedure. As described, a complicated procedure may be carried out in analyzing the failure.

Patent Document 1 and Patent Document 2 disclose techniques in which a process of another program (hereinafter, referred to as “add program”) automatically interrupts the running program at an arbitrary position of the running program. In this, a position to be diagnosed may be arbitrarily determined. It is possible for the add program to refer to the values of variables of the program to be diagnosed.

However, a management server is provided in the technique disclosed in Patent Document 1 and Patent Document 2. This is because the apparatuses are only passively prepared for operations of the add programs, and the management server instructs the apparatuses to introduce the add programs to the apparatuses and to operate the apparatuses. The management server is ordinarily constructed by a personal computer (PC) owned by a user who is an entity or a natural person having the right to use the apparatus or a PC owned by a provider of the apparatus. However, these uses of the PCs may not be preferred by the user.

Said differently, when the management server is constructed by the PC owned by the user, the user may bear various costs for the PC used as the management server.

Meanwhile, when the management server is constructed by the PC owned by the provider of the apparatus, the user confronts information security issues.

Patent Document 1: Japanese Laid-Open Patent Application No. 2009-146387

Patent Document 2: Japanese Laid-Open Patent Application No. 2008-269163

### SUMMARY OF THE INVENTION

Accordingly, embodiments of the present invention may provide a novel and useful image forming apparatus which simplifies a system structure by enabling operating an add program that dynamically interrupts an original program and a program controlling method solving one or more of the problems discussed above.

One aspect of the embodiments of the present invention may be to provide an image forming apparatus including a management unit configured to receive an instruction for operating a second program which can be dynamically inserted into a first program installed in the image forming apparatus from an operator, a control unit configured to carry out a process corresponding to the instruction for operating the second program in response to the instruction received via the management unit, and an install unit configured to install a program which causes the image forming apparatus to function as the management unit, wherein the management unit causes a first screen for enabling selecting the second program displayed on a display unit, acquires the second program selected from the first screen, and instructs the control unit to validate the acquired second program, and the control unit applies the second program by inserting the second program into the first program in response to the instruction of validating the second program.

Additional objects and advantages of the embodiments will be set forth in part in the description which follows, and in part will be clear from the description, or may be learned by practice of the invention. Objects and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF THE DRAWINGS

FIG. 1 illustrates an example hardware configuration of an image forming apparatus of Embodiment.

FIG. 2 illustrates an example software configuration of the image forming apparatus of Embodiment.

FIG. 3 illustrates an example procedure in executing an add program.

FIG. 4 illustrates an example functional configuration of an add program managing application.

FIG. 5 illustrates an example state transition of the add program in the image forming apparatus.

FIG. 6 is an example flowchart illustrating an installation of an add program managing application.

FIG. 7 illustrates a structural example of an application information file.

FIG. 8 is an example sequence diagram illustrating a procedure of the image forming apparatus which is executed by an add program managing application.

FIG. 9 is an example display of a log-in screen.

FIG. 10 is an example display of a management screen.

FIG. 11 illustrates a structural example of a state memory unit.

FIG. 12 is an example display of a download screen.

### DETAILED DESCRIPTION OF THE PREFERRED EMBODIMENTS

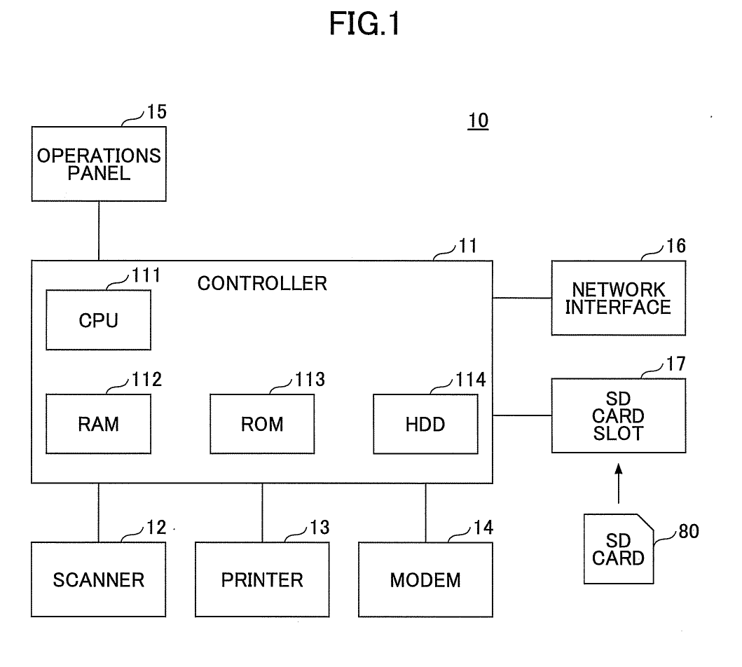

A description is given below, with reference to the FIG. 1 through FIG. 12 of embodiments of the present invention.

Reference symbols typically designate as follows:
10: Image forming apparatus;
11: Controller;
12: Scanner;
13: Printer;
14: Modem;
15: Operations panel;
16: Network interface;
17: SD slot card;
21: Authentication controlling unit;
22: Management unit;
23: Acquisition unit;
24: Transmission unit;
25: Validation unit;
26: Invalidation unit;
27: Delete unit;
28: State memory unit;
30: External recording medium;
121: Standard application;
122: SDK application;
123: SDK platform;
124: Application management service;
125: Add program control unit;
126: Control service;
127: OS;
1221: Add program managing application; and
1261: Authentication processing unit.

### Embodiment

FIG. 1 illustrates an example hardware configuration of an image forming apparatus 10 of one embodiment. Referring to FIG. 1, the image forming apparatus 10 includes hardware such as a controller 11, a scanner 12, a printer 13, a modem 14, an operations panel 15, a network interface 16, an SD card slot 17, and so on.

The controller 11 includes a CPU 111, a RAM 112, a ROM 113, an HDD 114, and so on. Various programs and data used by the various programs are stored in the ROM 113. The RAM 112 is used as a memory area for loading the programs, a work area for the loaded programs, or the like. The CPU 111 performs various functions by processing the programs loaded into the RAM 112. The HDD 114 records programs, various data used by the programs, or the like.

The scanner is hardware for reading image data from a manuscript. The printer 13 is hardware for printing print data on a print paper. The modem 14 is hardware for connecting the image forming apparatus 10 to a telecommunication line (not illustrated) and is used for sending and receiving the image data with fax communications. The operations panel 15 is hardware provided with an input means for receiving an input from a user and a display means such as a liquid crystal panel. The network interface 16 is hardware for connecting the image forming apparatus 10 to a wired or wireless network such as a LAN. The SD slot card 17 is used to read a program recorded in an SD card 80. Said differently, not only the programs stored in the ROM 113 but also the programs stored in the SD card 80 may be loaded into the RAM 112 and executed by the image forming apparatus 10. The SD card 80 may be substituted by any kind of recording media including a CD-ROM and a universal serial bus (USB) memory used via corresponding hardware interface devices.

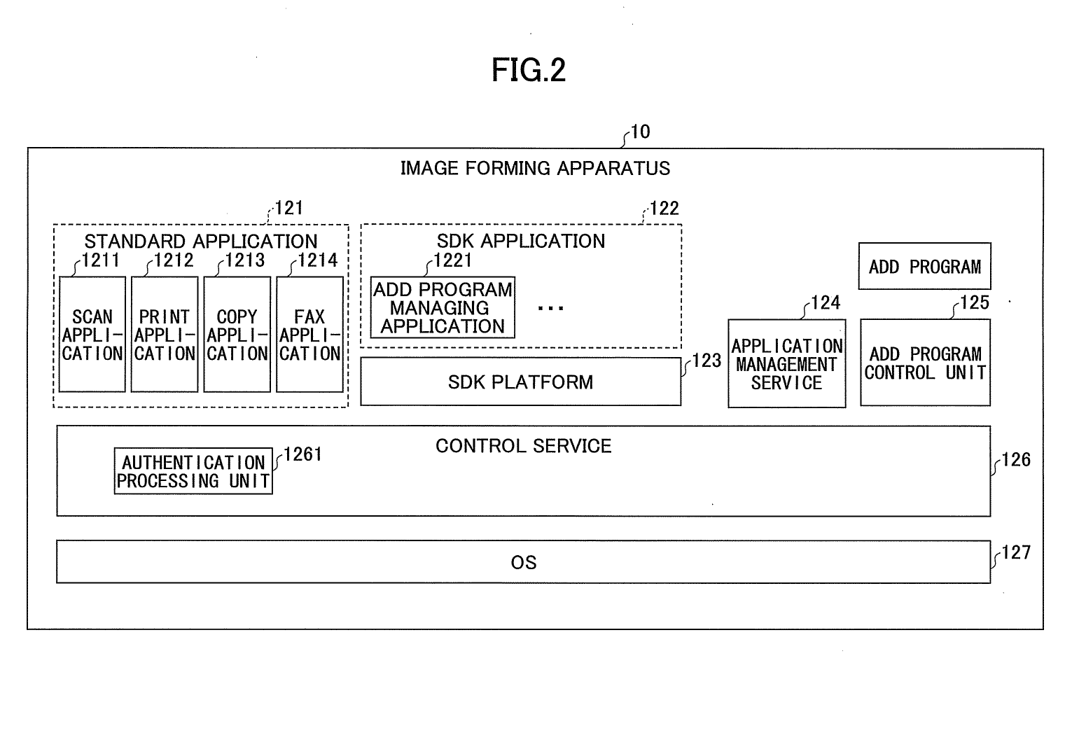

FIG.2 illustrates an example software configuration of the image forming apparatus 10 of one embodiment. Referring to FIG. 2, the image forming apparatus 10 includes a standard application 121, an SDK application 122, an SDK platform 123, an application management service 124, an add program control unit 125, a control service 126, and an OS 127.

The OS 127 is an operating system. Various software components installed in the image forming apparatus 10 function as processes or threads.

The control service 126 is a group of software modules which is used by a group of upper level software modules in common. Referring to FIG. 2, an authentication processing unit 1261 is illustrated as a part of the control service 126. The authentication processing unit 1261 provides a service of carrying out an authentication process after receiving a user name and a password. Further, the control service 126 includes software modules providing a service related to network communications, a service related to control of scanners, a service related to control of printers, a service related to management of memories, or the like.

The standard application 121 is a group of applications originally and ordinarily preinstalled in the image forming apparatus 10 before delivery. Referring to FIG. 2, a scan application 1211, a print application 1212, a copy application 1213, and a FAX application 1214 are illustrated. The scan application 1211 carries out scan jobs. The print application 1212 carries out print jobs. The copy application 1213 carries out copy jobs. The FAX application 1214 carries out facsimile transmitting and receiving jobs.

The SDK application 122 can be installed or uninstalled as a plug-in for carrying out a feature extension of the image forming apparatus 10 after delivering and installing the image forming apparatus 10. An add program managing application 1221 is illustrated as the SDK application 122. The add program managing application 1221 provides an interface to a user for operating the add program.

The SDK platform 123 provides an execution environment for the SDK application 122. The SDK applications 122 are developed using an application program interface (hereinafter, referred to as SDKAPI) which is provided by the SDK platform. For example, the SDK platform 123 provides the SDK application 122 with an SDKAPI for a scan function, an SDKAPI for a print function, an SDKAPI for a copy function, and so on. The SDK platform 123 realizes services corresponding to the SDKAPIs using service functions provided by the control service 126 in response to calling from the SDKAPI. The SDK platform 123 also plays a role in hiding the service interface of the control service 126 due to, for example, information security reasons and providing an easily usable API to a developer of the SDK application 122. The SDKAPI is publicly open, and the SDK applications may be developed by a third-party vendor.

The application management service 124 manages the SDK application 122. The application management service 124 installs or uninstalls the SDK application 122 into the image forming apparatus 10. The application service 124 manages list information of the SDK application 122 installed in the image forming apparatus 10 with the HDD 114.

The add program control unit 125 controls the add program based on an instruction from the add program managing application 1221.

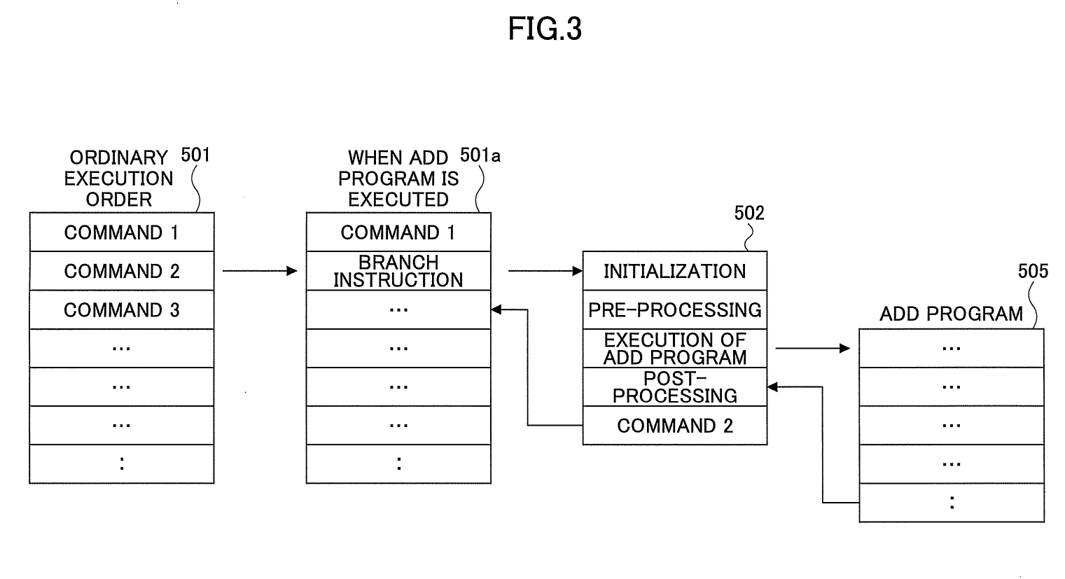

The add program 505 is described below. FIG. 3 illustrates an example procedure in executing the add program 505.

Referring to FIG. 3, commands of an originally or ordinarily installed program (hereinafter referred to as “original program”) to which the add program 505 is to be applied are schematically arranged in a virtual memory. The original program may include the scan application 1211, the print application 1212, the copy application 1213, and the FAX application 1214 described above and further any program to which the add program 505 is applied to modify the original program. The original program carries out the commands 1, 2, and 3 in this sequence (order) of the original program 501 before the add program 505 is applied (ordinary execution). When the add program 505 is applied to the original program, the sequence (order) of the original program 501 is changed to a sequence (order) 501a. In the sequence (order) 501a, a process of the add program 505 interrupts between the command 1 and the command 2. Then, the command 2 is replaced by a branch instruction indicative of moving to a table 502. The table 502 is defined to carry out an initialization process, a pre-process for sending variables to a stack for escape, a call process of calling the add program 505, a post-process of taking back the variables sent to the stack, and the command 2. Then the execution order returns to the command 3 of the sequence (order) of the original program 501.

When the add program 505 is applied, the add program 505 is carried out when an execution step reaches a predetermined position (add position) of the original program. After the add program 505 is carried out, the process goes back to the original program. The original program restarts its process from the add position. The add program 505 includes a process of interrupting the original program, an add program code, and an information piece for identifying the original program and the add position.

It is enabled for the add program 505 to refer to the variables of the original program. Therefore, the add program 505 can interrupt the original program to add a process of outputting log information indicative of the value of a variable at an arbitrary position of the original program, a process of correcting bugs, and a process of realizing a new function.

The above described add program 505 can modify, be compiled with, or be linked to the source code of the original program. Further, the add program 505 can dynamically output log information, correct bugs, or enforce the functions of the original program without reinstalling the add program.

In one embodiment, “validation” of the add program is an application of the add program 505 to the original program to enable execution of the add program 505. Said differently, “validation” of the add program is carried out by loading the add program 505 into the memory and inserting the branch instruction enabling processing of the loaded add program 505 into the original program. Said differently, the add program 505 does not function when it is stored in the image forming apparatus 10 and can be validated after inserting the process of the add program 505 into the original program.

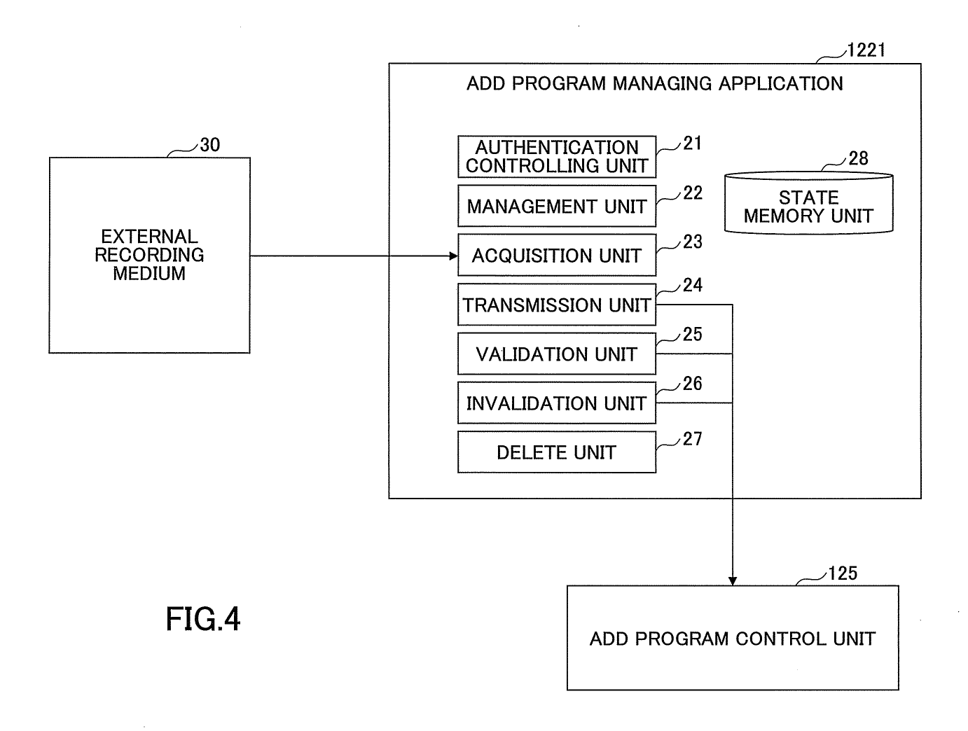

Next, the add program managing application 1221 is described in detail. FIG. 4 illustrates an example functional configuration of an add program managing application. The add program managing application 1221 includes an authentication controlling unit 21, a management unit 22, an acquisition unit 23, a transmission unit 24, a validation unit 25, an invalidation unit 26, a delete unit 27, a state memory unit 28, and so on.

The authentication controlling unit 21 controls a process for determining whether an operator has authority to use the add program managing application 1221. When the existence of the authority is confirmed by the authentication controlling unit 21, the operator is permitted to use the add program managing application 1221. The managing unit 22 causes a screen for receiving an operation instruction related to the add program 505 to display on the operations panel 15 and starts a process corresponding to the operation instruction via the screen.

The acquisition unit 23 downloads or acquires the add program 505 from an external recording medium 30. The external recording medium 30 may be a portable recording medium such as an SD card or a USB memory connected to the image forming apparatus 10 or a computer such as a personal computer (PC). In any type of the external recording media 30, the add programs are stored in association with identifiers (add program ID) of the add programs. The add program 505 acquired by the acquisition unit 23 is stored in the HDD 114 in association with the add program ID. Hereinafter, add programs including the acquired add program are referred to as candidate add programs. Said differently, the acquired add program may be selected from the candidate add programs.

The transmission unit 24 transmits the add program 505 acquired by the acquisition unit 23 to the add program control unit 125. The validation unit 25 gives an instruction to validate the add program 505 to the add program control unit 125 when the user gives the instruction to validate the add program. The invalidation unit 26 instructs the add program control unit 125 to invalidate the add program 505 to the add program control unit 125 when the user requests to invalidate the add program 505. The invalidation is to release the application of the add program 505 to the original program. The delete unit 27 deletes the add program 505 stored in the HDD 114 when the user instructs to delete the add program 505 stored in the HDD 114. The state memory unit 28 is a memory region in which information indicative of a state of the add program 505 is stored in the HDD 114. The memory region may be a file or a database.

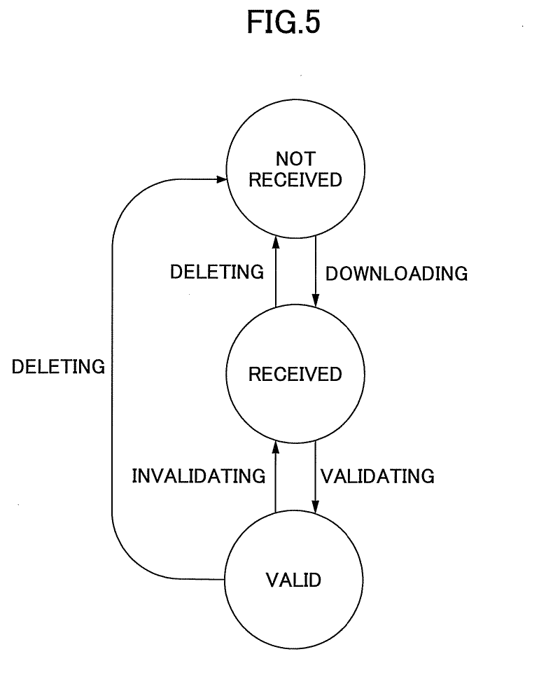

In Embodiment, the state of the add program 505 transits as illustrated in FIG. 5. FIG. 5 illustrates an example state transition of the add program 505 in the image forming apparatus. As illustrated in FIG. 5, the add program 505 in the image forming apparatus is in any one of the states of “not received”, “received”, or “valid”.

In the “not received” state, the add program 505 is not received or downloaded from the external recording medium 30. Said differently, the add program 505 does not exist in the image forming apparatus 10. When the add program 505 is downloaded into the image forming apparatus, the “not received” state transits (is changed) to the “received” state. The add program 505 in the “received” state is merely stored in the HDD 114 and not yet applied to the original program. Therefore, the add program 505 is not executed in the “received” state. When it is instructed to validate the add program 505 of the “received” state, the “received” state transits (is changed) to the “valid” state. When the add program 505 of the “valid” state reaches the add position of the original program, the process of the add program 505 interrupts the process of the original program.

When it is instructed to invalidate the add program 505 from the “valid” state, the state of the add program 505 returns to the “received” state. When the add program 505 is deleted, the state of the add program 505 returns to the “not received” state. However, when the add program of the “valid” state is deleted, the add program 505 is once invalidated and then deleted.

The transition of the states occurs when the user inputs an operation instruction. Said differently, arrows in FIG. 5 correspond to operation instructions which can be input by the user to the add program 505.

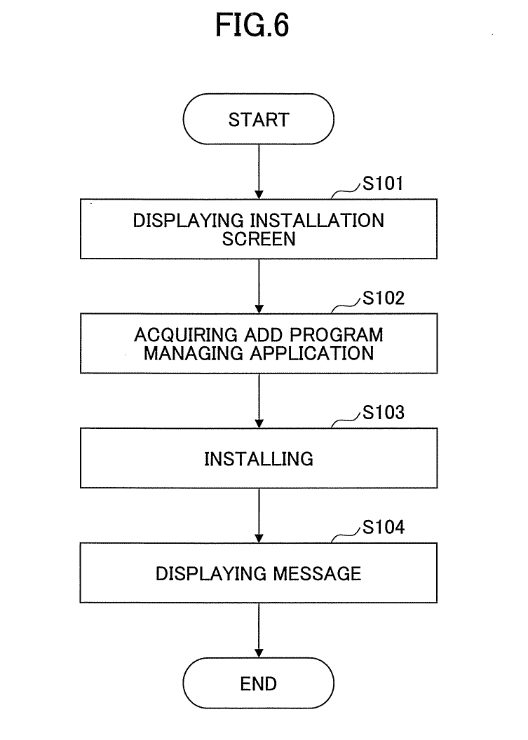

Next, the procedure in the image forming apparatus 10 is described. FIG. 6 is an example flowchart illustrating installation of the add program managing application 1221. Referring to FIG. 6, before “START”, the add program managing application 1221 is not yet installed into the image forming apparatus 10.

In step S101, the application management service 124 causes an installation screen to be displayed on the operations panel 15. A storage location of the SDK application 122 to be installed is designated on the installation screen. Here, the SDK application 122 to be installed is the add program managing application 1221. The storage location may be an SD card connected to the image forming apparatus 10, a computer connected to the image forming apparatus 10 via the network, or the like.

When the storage location of the add program managing application 1221 to be installed is designated, the application management service 124 acquires an archival file of the add program managing application 1221 in step S102. Subsequently, the application management service 124 decompresses the archival file and carries out installation of the execution file of the add program managing application 1221 in step S103. As a part of the installation, the application management service 124 stores an application information file copied or sent from the archival file in a predetermined position of the HDD 114. The application information file is described in a form common to the SDK applications.

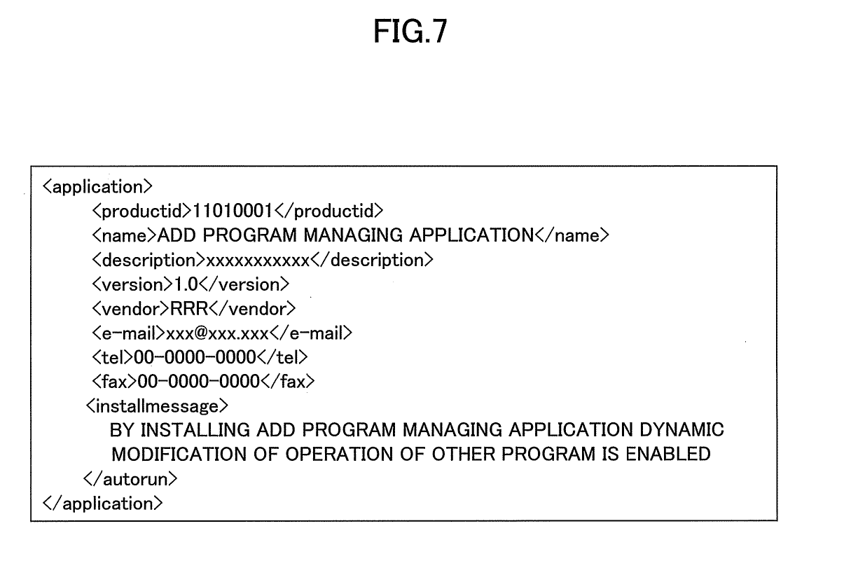

FIG. 7 illustrates a structural example of an application information file. Referring to FIG. 7, the application information file is described in an eXtensible Markup Language (XML) form in which application elements surrounded by tags of <application> and </application> are used as route elements.

Sub-elements of the <application> element correspond to attribute items of the SDK application 122. The value of sub-element <productid> indicates a product ID of the add program managing application 1221. The value of sub-element <name> indicates an application name. The value of sub-element <description> indicates an explanation about the SDK application 122. The value of sub-element <version> indicates a version of the SDK application 122. The value of sub-element <vendor>indicates a vendor developing the SDK application 122. The values of sub-elements <e-mail>, <tel>, and <fax> indicate an e-mail address, a telephone number, and a fax number of the vendor, respectively. The value of sub-element < > indicates a message displayed when the installation succeeds.

It becomes possible to obtain a list of the SDK application 122 installed in the image forming apparatus 10 when the application information file is stored in a predetermined position of the HDD 114 in response to the installation of the SDK application 122 into the image forming apparatus 10.

After the installation is completed, the application management service 124 displays the value of sub-element <installmessage> of the application information file on the operations panel 15 in step S104. Then, a message of “By installing add program management application, dynamic modification of operation of other program is enabled.” is displayed. With this message, it becomes possible to promote awareness of the user about security of the programs included in the image forming apparatus 10. Although it is convenient to dynamically modify the existing program to be applied with the add program, there may be caused degradation of security as a side effect of the convenience.

After the add program managing application 1221 is installed, the function of the add program control unit 125 becomes substantially valid. This is because the add program control unit 125 functions when it is used by the add program managing application 1221.

Subsequently, the process of the image forming apparatus 10 into which the add program managing application 1221 is installed is described.

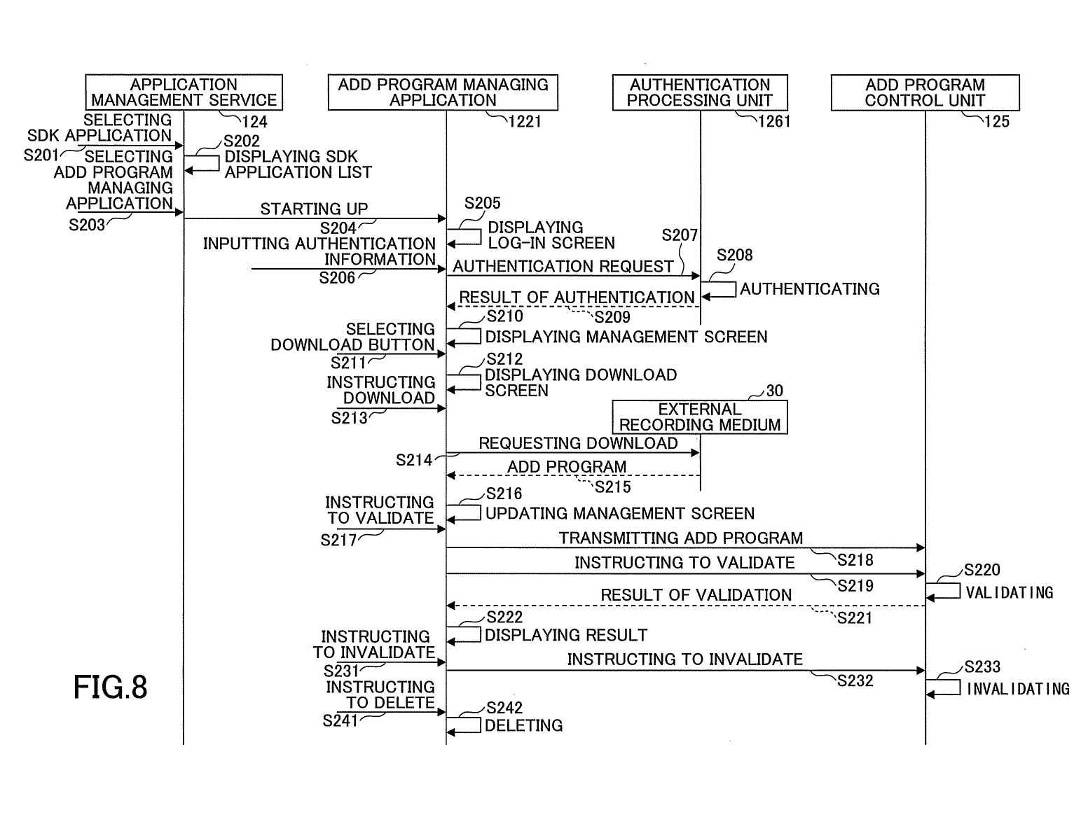

FIG. 8 is an example sequence diagram illustrating the procedure of the image forming apparatus 10 which is executed by the add program managing application 1221.

In step S201, when a predetermined hardware key (not illustrated) on the operations panel 15 is pushed down, an event corresponding to this action is reported to the application management service 124. Hardware keys for selecting the applications are arranged corresponding to the standard applications 121 such as the scan application 1211, the print application 1212, the copy application 1213, and the FAX application 1214. This is because the standard applications are predetermined as being assembled into the image forming apparatus 10. However, the SDK application 122 does not always exist in the image forming apparatus 10. Therefore, one hardware key is allocated to the group of the SDK applications 122 as an SDK application selecting key. In step S201, the SDK application selecting key is pushed down.

The application management service 124 causes the SDK application list screen to display on the operations panel 15 after the SDK application selection key is pushed down in step S202. Starting buttons are displayed for each of the SDK applications 122 installed in the image forming apparatus 10. Therefore, in one embodiment, a starting button for the add program managing application 1221 is also displayed. The application management service 124 causes the SDK application list screen to display based on the group of the application information files stored in the HDD 114.

When the button of the add program managing application 1221 is pushed down on the SDK application list screen in step S203, the application management service 124 makes the add program managing application 1221 start up as a subject of the operation in step S204. The authentication controlling unit 21 of the add program managing application 1221 makes a log-in screen display on the operations panel 15 when the add program managing application 1221 is started up in step S205.

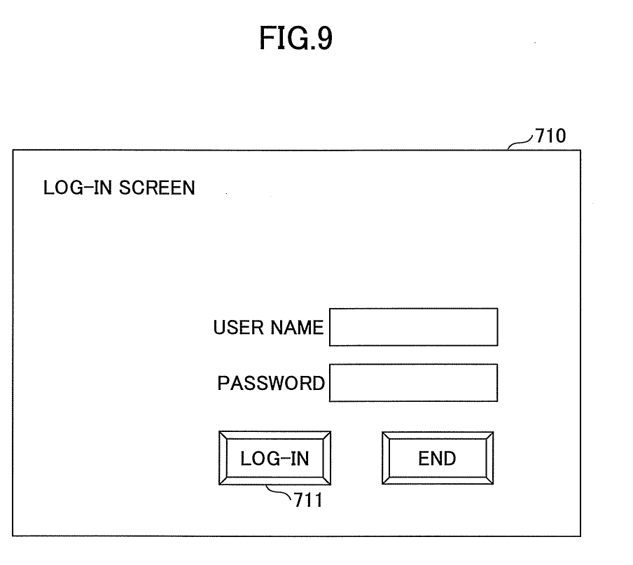

FIG. 9 is an example display of the log-in screen. As illustrated in FIG. 9, the log-in screen 710 has entry fields of a user name and a password.

When authentication information such as the user name and the password is input through the log-in screen 710 and a log-in button 711 is selected in step S206, the authentication controlling unit 21 inputs the user name and the password into the authentication processing unit 1261 and requests execution of the authentication in step S207. The authentication controlling unit 21 authenticates the user by determining or checking whether the input user name and password are the same as the user name and password included in the user information previously stored in the HDD 1121 in step S208, and outputs the result of the authentication to the authentication controlling unit 21 in step S209.

When the result of the authentication output from the authentication processing unit 1261 indicates success of the authentication, the management unit 22 of the add program managing application 1221 causes a management screen 720 to display on the operations panel 15 in step S210.

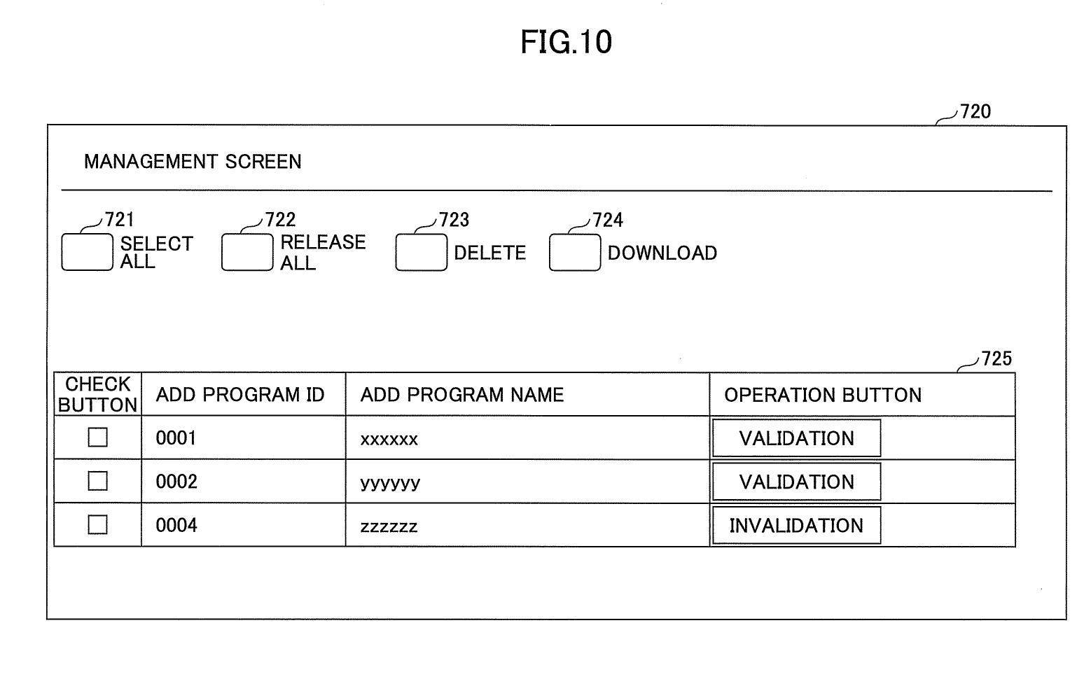

FIG. 10 is an example display of the management screen 720. Referring to FIG. 10, the management screen 720 includes a select all button 721, a release all button 722, a delete button 723, a download button 724, and an add program list table 725.

The add program list table 725 displays check buttons, add program IDs, add program names, operation buttons and so on with respect to the add programs already downloaded into the image forming apparatus 10. The check buttons are used for selecting the add programs to be operated. The operations button receives an input of instructions of validating or invalidating the add program. In the add program 505 under the “valid” state, a character string of “invalidation” is displayed for a selection. In the add program 505 under the “received” state, a character string of “validation” is displayed for a selection. The processes carried out when the operation buttons are selected differ depending on the states of the add program 505 corresponding to the operation buttons. The management unit 22 causes the contents of the add program list table 725 to be displayed based on the information stored in the state memory unit 28.

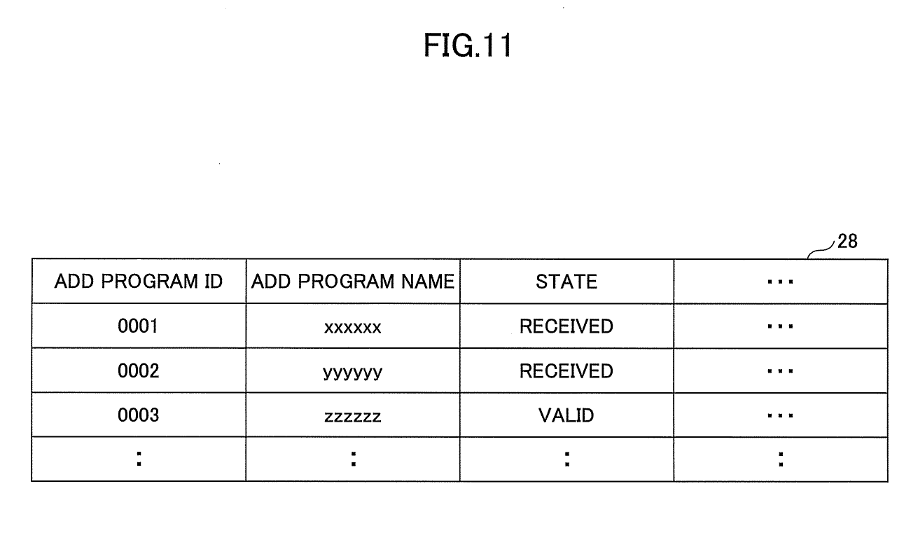

FIG. 11 illustrates a structural example of the state memory unit 28. Referring to FIG. 11, the state memory unit 28 stores add program IDs, add program names, and states of the add programs by associating the add programs with the add program IDs, add program names, and states.

Referring back to FIG. 10, the select all button 721 is provided for selection of all the check buttons included in the add program list table 725. The release all button 722 is provided for release of all the selected check buttons included in the add program list table 725. The delete button 723 is provided to receive an instruction of deleting the add programs of which check buttons are selected in the add program list table 725. The download button 724 is provided to receive an instruction of downloading the add programs from the external recording medium 30.

In the management screen 720, when the download button 724 is selected in step S211, the acquisition unit 23 of the add program managing application 1221 causes the download screen to display on the operations panel 15 in step S212.

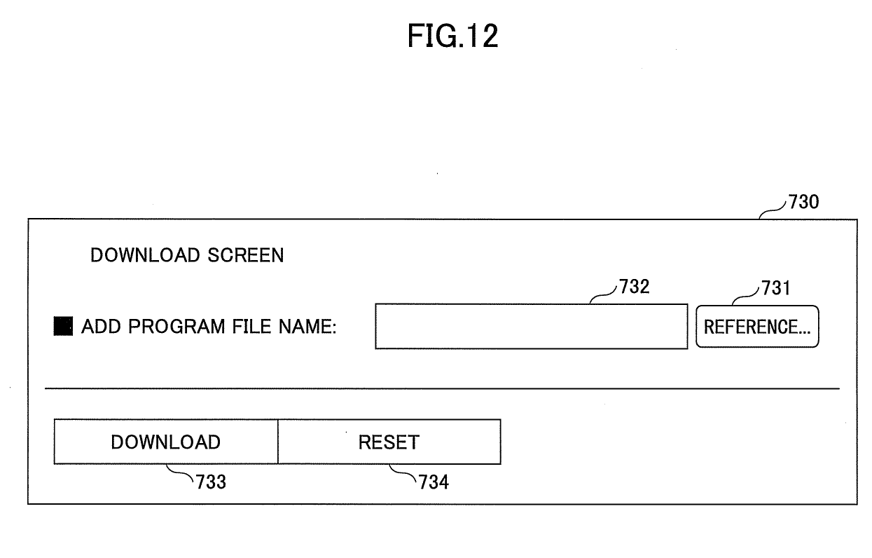

FIG. 12 is an example display of a download screen 730. Referring to FIG. 12, the download screen 730 includes a reference button 731, a text box 732, a download button 733, and a reset button 734.

When the reference button 731 is selected, the acquisition unit 23 causes the display of a file dialogue showing a file list of the add programs stored in the external recording medium 30. When a preferred add program 505 is selected on the file dialogue, the acquisition unit 23 recognizes the selected add program 505 as an object of the download, stops the display of the file dialogue, and displays the file name of the add program 505 in the text box 732. When the reset button is selected, the acquisition unit 23 clears the content of the text box 732, i.e. the file name of the add program 505 to be downloaded.

When the download button 733 is selected in step S213, the acquisition unit 23 downloads the add program 505, the file name of which is displayed in the text box 732, from the external recording medium 30 and stores the add program 505 which is downloaded to the HDD 114 in steps S214 and S215. The acquisition unit 23 adds a record related to the downloaded add program 505 to the state memory unit 28. At this time, the state of the record in the state memory unit 28 becomes “received”.

After the download is completed, the management unit 22 causes the management screen 720 to display on the operations panel 115 in step S216. The display content of the management screen 720 in step S216 is based on the updated state memory unit 28. Therefore, the display content of the management screen 720 in step S216 is different from the display content of the management screen 720 in step S210. A row related to the newly downloaded add program 505 is added to the add program list table 725.

Subsequently, when an operation button having a label of “validation” is pushed down on the add program list table 725 of the management screen 720 in step S217, the transmission unit 24 acquires the add program 505 corresponding to the operation button from the HDD 114 and transmits the acquired add program to the add program control unit 125 in step S218. The add program control unit 125 loads the received add program 505 in a memory so that the add program 505 can be executed. Subsequently, the validation unit 25 designates the program ID of the add program 505 transmitted by the transmission unit 24 and transmits an instruction for validating the add program 505 to the add program control unit 125 in step S219. Upon instruction to validate the add program 505, the add program control unit 125 validates the add program 505 corresponding to the designated add program ID in step S220. Said differently, a branch instruction pointing toward the add program 505 is inserted into the original program so that the add program 505 can be applied with such as the standard application 121 and the SDK application 122. Therefore, instead of an execution of the add position of the original program to be applied with the add program, the add program 505 is carried out. As a result, functions assembled into the add program 505 such as a log output, a bug correction, a feature extension, or the like are added to the original program to be applied with the add program 505.

Subsequently, the add program control unit 125 returns an execution result whether the validation is successful to the validation unit 25 in step S221. The validation unit 25 makes a message indicative of the execution result display on the operation panel 15 in step S222. When the validation is successful, the validation unit 25 updates a value of the state of the validated add program 505 stored in the state memory unit 28 with “valid”.

On the other hand, when an operation button of which label is “invalidation” is selected in the add program list table 725 of the management screen 720 in step S231, the invalidation unit 26 designates the add program ID corresponding to the selected operation button and transmits an instruction to invalidate the add program 505 to the add program control unit 125 in step S232. Upon receipt of the instruction to invalidate the add program 505, the add program control unit 125 invalidates the add program 505 corresponding to the designated add program ID in step S233. Said differently, the application of the add program 505 to the original program to be applied with the add program 505 is released. More specifically, the branch instruction pointing toward the add program 505 is removed from the program code of the original program to be applied with the add program 505. As a result, the sequence of the original program to be applied with the add program 505 returns back to the original sequence. When the invalidation is successful, the invalidation unit 26 updates a value of the state of the invalidated add program 505 stored in the state memory unit 28 with “received”.

When the delete button 723 is selected on the management screen 720 in step S241, the delete unit 27 of the add program managing application 1221 deletes the add program 505, of which check button is selected in the add program list table 725, from the HDD 114 in step S242. When the deletion is successful, the delete unit 27 updates a value of the state of the deleted add program 505 stored in the state memory unit 28 with “not received”.

As described, the image forming apparatus 10 of one embodiment includes the add program managing application 1221 which realizes the functions installed in the management server. Thus, operations related to the add program 505 can be independently carried out by one image forming apparatus 10 without adding another apparatus or the like. As a result, an installation of a management server becomes unnecessary, and add programs 505 are used by a simpler system configuration.

By actually installing the add program managing application 1221 as one of the SDK applications 122, an authentication function installed in the image forming apparatus 10 may be used by the add program managing application 1221 in common with the image forming apparatus 10. As a result, it becomes possible to limit the use of the add program managing application 122 depending on an access control function of the image forming apparatus 10.

By simplifying the system configuration, it is possible to improve an independence of the image forming apparatus 10 in operating add programs 505. Specifically, when a single management server is allocated to plural image forming apparatuses 10 and a failure occurs in the management server, it becomes impossible to operate the add programs 505 for all the image forming apparatuses 10. On the other hand, by executing the add program 505 for each image forming apparatus 10 without the single management server, it is possible to avoid the failure from occurring.

The add program managing application 1221 can be installed or uninstalled. Therefore, it is possible to allow a user to determine whether the add program 505 is to be applied to the system environment including the image forming apparatus 10 after considering both convenience and a disadvantage in installing the add program managing application 1221. The convenience in installing the add program managing application 1221 is obtainable by enabling dynamically changing the sequence of the program assembled or installed in the image forming apparatus 10. The disadvantage in installing the add program managing application 1221 may occur when the sequence of the program assembled or installed in the image forming apparatus 10 is dynamically changed. For example, the changed program may be excluded from a security authentication such as P2600.

Various screens of the add program managing application 1221 may be communicated on a network as a Web page containing such as HyperText Markup Language (HTML) data. In this case, it becomes possible to operate the add program managing application 1221 via not only the operations panel 15 but also a Web browser installed in such as a personal computer (PC) connected to the image forming apparatus 10 through a network.

Further, although the image forming apparatus is exemplified as an electronic apparatus in one embodiment, the present invention is not limited to the image forming apparatus and may be applied to various electronic apparatuses. For example, the present invention may be effectively applicable to various digital consumer electronics devices, mobile devices, general-purpose computers, or the like.

As described, the system configuration enabling dynamically interrupting the other programs with an add program 505 may be simplified by the embodiments.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority or inferiority of the invention. Although the embodiment of the present invention has been described in detail, it should be understood that various changes, substitutions, and alterations could be made thereto without departing from the spirit and scope of the invention.

This patent application is based on Japanese Priority Patent Application No. 2009-238979 filed on Oct. 16, 2009, the entire contents of which are hereby incorporated herein by reference.

What is claimed is:

1. An image forming apparatus comprising:
a management unit configured to receive an instruction from an operator for operating a second program which can be dynamically inserted into a first program installed in the image forming apparatus;
a control unit configured to carry out process corresponding to the instruction for operating the second program in response to the instruction received via the management unit;
an install unit configured to install a program which causes the image forming apparatus to function as the management unit,
wherein the management unit causes a first screen for enabling selecting the second program to be displayed on a display unit, acquires the second program selected from the first screen, and instructs the control unit to validate the acquired second program, and
the control unit applies the second program by inserting the second program into the first program in response to the instruction to validate the second program.

2. The image forming apparatus according to claim 1,
wherein the management unit causes a second screen including a list of candidate second programs to display on the display unit, and instructs the control unit to validate the second program selected from the list on the second screen.

3. The image forming apparatus according to claim 2,
wherein the management unit causes a state memory unit to store state information indicative of the application of the second program to the first program, and causes a display component enabling selecting validation or invalidation for each of the candidate second programs included in the list based on the state information to be displayed on the second screen.

4. The image forming apparatus according to claim 3,
wherein the management unit instructs invalidating the second program which is selected to be invalidated via the display component, and
the control unit releases the application of the second program to the first program upon receipt of the instruction to invalidate the second program.

5. A program controlling method comprising:
enabling to select a second program, which can be dynamically inserted into a first program installed in an image forming apparatus, in a first screen displayed on a display unit of the image forming apparatus,
acquiring the second program selected from the first screen;
receiving an instruction for operating the selected second program (from the operator);
carrying out a process corresponding to the instruction for operating the selected second program in response to the received instruction;
instructing validating the second program, and
applying the second program by inserting the second program into the first program in response to the instructing validating.

6. The program controlling method according to claim 5, further comprising:
displaying a second screen including a list of candidate second programs on the display unit,
wherein, in the enabling, the second program is selected from the list of the candidate second programs.

7. The program controlling method according to claim 6, further comprising:
causing a state memory unit to store state information indicative of the application of the second program to the first program; and
causing a display component enabling selecting validation or invalidation for each of the candidate second programs included in the list based on the state information to be displayed on the second screen.

8. The program controlling method according to claim 7, further comprising:
instructing invalidating the second program which is selected to be invalidated via the display component; and
releasing the application of the second program to the first program upon receipt of the instruction to invalidate the second program.

9. A non-transitory storage medium storing a computer program for causing a computer to execute a program controlling method, the program controlling method comprising:
enabling selecting a second program, which can be dynamically inserted into a first program installed in an image forming apparatus, in a first screen displayed on a display unit of the image forming apparatus,
acquiring the second program selected from the first screen;
receiving an instruction for operating the selected second program;
carrying out a process corresponding to the instruction for operating the selected second program in response to the received instruction;
instructing validating the second program, and
applying the second program by inserting the second program into the first program in response to the instructing validating.

10. The non-transitory storage medium according to claim 9, further comprising:
displaying a second screen including a list of candidate second programs on the display unit,
wherein, in the enabling, the second program is selected from the list of the candidate second programs.

11. The non-transitory storage medium according to claim 10, further comprising:
causing a state memory unit to store state information indicative of the application of the second program to the first program; and
causing a display component enabling selecting validation or invalidation for each of the candidate second programs included in the list based on the state information to be displayed on the second screen.

12. The non-transitory storage medium according to claim 11, further comprising:
instructing invalidating the second program which is selected to be invalidated via the display component; and
releasing the application of the second program to the first program upon receipt of the instruction to invalidate the second program.
